(19) United States
(12) Patent Application Publication
(10) Pub. No.: US 2006/0004737 A1
(43) Pub. Date: Jan. 5, 2006

(54) Computer virus protection for automated pharmaceutical processes

(76) Inventor: Michael T. Grzonka, Hudson, NH (US)

Correspondence Address: MILLIPORE CORPORATION, 290 CONCORD ROAD, BILLERICA, MA, 01821, US

(21) Appl. No.: 10/884,706

(22) Filed: Jul. 2, 2004

(51) Int. Cl. G06F 17/30

(52) U.S. Cl. 707/4

(57) ABSTRACT

Techniques are disclosed for protecting a computer system from computer virus infection by identifying a set of files authorized for storage in the computer system. The authorized set of files may be identified at the time the computer is configured for use. The computer may be scanned periodically for files not in the authorized set. If any unauthorized file is found, an appropriate action is taken in response, such as notifying a system administrator, shutting down the computer, or taking the computer offline. In addition, the computer's process table may be scanned to identify any unauthorized processes. If any such processes are identified, an appropriate action may be taken in response, such as notifying a system administrator, shutting down the computer, or taking the computer offline.

### FIELD

The present invention relates to computer security and, more particularly, to techniques for protecting computers against computer viruses.

### BACKGROUND

A computer “virus” is a software program that is capable of executing and copying itself to other computers automatically, much like a biological virus is capable of infecting a living host and then transmitting itself to other hosts. Although some viruses are benign (such as those which merely display a message to the user without causing any harm), many computer viruses perform malicious actions, such as deleting files or transmitting private information to a third party without the permission (or even knowledge) of the user. The threat posed by computer viruses continues to increase as computers become increasingly interconnected over a combination of private networks and the public Internet, and as virus authors devise viruses that are able to perform increasingly malicious functions, to propagate themselves increasingly rapidly, and to hide their origins and the traces of their activity with increasing degrees of success.

Various systems exist for protecting computers against viruses. In some systems, “virus scanning” software executes on a server or client computer. For example, referring to FIG. 1, a block diagram is shown which illustrates a prior art system 100 including a client computer 102 executing virus scanning software 104. The virus scanning software 104 maintains a database 106 of known computer viruses and determines whether a particular file contains a virus by comparing the contents of the file to the contents of the virus database 106. If a match is found, the matching file may be deleted or otherwise prevented from executing, such as by storing the file in a quarantine 108 that is not accessible to the remainder of the computer system 102, thereby preventing the infected file from causing damage.

Every incoming file received by the computer 102 and every outgoing file transmitted by the computer 102 may be scanned. For example, in the system 100 illustrated in FIG. 1, incoming email messages 110 received over a network 112 (such as the public Internet or a private intranet) are scanned by the virus scanning software 104 using the virus database 106. The virus scanning software 104 transfers any infected messages to the quarantine 108. For example, infected message 112a has been filtered by the virus scanning software 104 and stored in the quarantine 108. The virus scanning software 104 forwards any non-infected messages 114 to an email client 116 executing on the computer 102. The virus scanning software 104 in effect operates as a filter on the incoming email messages 110. Although not shown in FIG. 1, the virus scanning software 104 may perform a similar function for outgoing email messages generated by the email client 116.

Alternatively or additionally, every file stored on the computer 102 may be scanned to determine whether any of the files contains a virus. For example, the computer 102 illustrated in FIG. 1 includes a hard disk 118 containing a plurality of files 120. The virus scanning software 104 may scan the files 120 for viruses using the virus database 106. Upon finding an infected file, the virus scanning software 104 may delete the file, transfer the file to the quarantine 108 (as illustrated by infected file 112b), or take other appropriate action.

A typical personal computer hard disk may contain tens, or even hundreds, of thousands of files. The virus scanning software 104 may be instructed by the user to scan all of the files 120 on the hard disk 118 for viruses. Users often choose to configure the virus scanning software 104 to scan the files 120 on the hard disk 118 periodically at predetermined times, such as at 2 am every Sunday, to avoid using critical computer resources for virus scanning during periods of peak usage.

A virus database in current systems may contain definitions of more than 64,000 distinct viruses. It is apparent, therefore, that comparing every file stored on, or received/transmitted by the computer 102, may consume a significant amount of computing resources. A full virus scan of a home user's personal computer may, for example, require several hours of computer time to complete. Email servers and other computers which are hubs of significant network traffic may need to devote a significant percentage of their computing time and other resources to scanning for viruses using conventional scanning techniques. For example, the typical time required for the Symantec Norton Antivirus™ virus scanning software to scan approximately 140,000 files on a computer having a 2.4 GHz processor and 512 MB of RAM is 35-40 minutes.

Recently, the MSBlast virus has demonstrated that the software infrastructure of the network itself can been used to spread malicious code. Such a virus, which does not use features of the operating system to execute or propagate itself, can be particularly difficult to detect using conventional virus detection techniques. The threat posed by such viruses is particularly real for systems that are connected to computer networks, since networks promote the exchange of information in general, including malicious code such as computer worms and other self-propagating objects.

Traditionally, critical computer systems, such as those used in pharmaceutical testing and manufacturing production, have operated essentially in isolation from any corporate networks out of a fear that such corporate networks would expose the critical computer systems to security threats and risk from virus attacks. Manufacturing networks, as far as they existed at all, were typically built on purely low-level, private networks using proprietary protocols. More recently, however, even computer systems operating in critical environments have begun to be implemented using personal computers on TCP/IP networks that are connected to the other networks outside the production area, such as corporate intranets, and, indirectly through those intranets, to the public Internet. At this time, the virus threat is typically underestimated for many Windows-based systems used in critical areas precisely because such computer systems have only recently begun to be connected to standardized networks at all, and many of the individuals involved in networking have a mechanical or electrical engineering background rather than a background in information technology.

Although such systems may utilize virus scanners and connect to the Internet through a firewall, such techniques do not provide perfect protection against viruses. In particular, such techniques only provide protection against known viruses defined in the virus database 106. If a new virus is propagated over the Internet, database-based systems may not be able to identify the virus as a virus until the antivirus software vendor issues a patch to the database 106. This may take anywhere between several hours and several days, during which time the virus may cause significant damage. With an ever-increasing number of viruses, the response time of vendors of database-based virus scanning tools will likely continue to increase for any particular virus, despite such vendor's best efforts. As a result, there is a “window of vulnerability” or a “window of concern”, during which malignant code can be executed on a particular computer without a database-based approach being able to detect such code as malignant. That “window of concern” opens when a malignant code or entity gets released into the public Internet; the window closes when a reliable detection mechanism is installed on a particular computer, for example in the shape of an updated virus database.

For as long as the “window of concern” is open, the virus scanning software 104, therefore, cannot protect against viruses which have not been reported and incorporated into the database 106. From a pharmaceutical production perspective there is an additional potential threat present: the integrity and authenticity of production records. While many of the viruses noticed by the general public have typically severe and easily-noticeable consequences, this need not be the case. The payload of a virus could very well begin to modify content within files kept in popular file formats (e.g., Microsoft Word, Adobe PDF, Windows .INI files, etc.) without destroying such files. Such a potential virus could act swiftly and subsequently erase itself from the affected system without leaving a trace behind that it ever was present. From a pharmaceutical production perspective such a virus would be far more damaging than a virus that, for example, erases files altogether, or that brings down the entire system.

What is needed, therefore, are improved techniques for protecting critical computer systems against computer viruses, particularly in the context of critical production processes such as in the pharmaceutical manufacturing and production environments.

### SUMMARY

Techniques are disclosed for protecting a computer system from computer virus infection by identifying a set of files authorized for storage in the computer system. The authorized set of files may be identified at the time the computer is configured for use. The computer may be scanned periodically for files not in the authorized set. If any unauthorized file is found, an appropriate action is taken in response, such as notifying a system administrator, shutting down the computer, or taking the computer offline. In addition, the computer's process table may be scanned to identify any unauthorized processes. If any such processes are identified, an appropriate action may be taken in response, such as notifying a system administrator, shutting down the computer, or taking the computer offline.

For example, in one embodiment of the present invention, techniques are disclosed for use in the manufacture of a pharmaceutical composition intended for the therapy of human diseases, wherein said manufacture involves at least one procedure that is both automated by a computer and critical to the safety or efficacy of said pharmaceutical composition. The following steps are performed: (A) creating on said computer an authorized reference that identifies a plurality of reference files authorized for use by said computer; and (B) operating on said computer a computer-implemented method comprising steps of: (1) identifying the authorized reference created on said computer; (2) determining, by reference to the authorized reference, whether a particular file stored in the computer is authorized for use by the computer; and (3) if it is determined that the particular file is not authorized for use by the computer, performing a first predetermined action.

In another embodiment of the present invention, a computer-implemented method is provided which includes steps of: (A) identifying an authorized file reference which identifies a plurality of reference files authorized for use by a computer system; (B) determining, by reference to the authorized file reference, whether a particular file stored in the computer system is authorized for use by the computer system; and (C) if it is determined that the particular file is not authorized for use by the computer system, performing a first predetermined action.

Other features and advantages of various aspects and embodiments of the present invention will become apparent from the following description and from the claims.

### BRIEF DESCRIPTION OF THE DRAWINGS

FIG. 1 is a block diagram illustrating a prior art system including a client computer executing virus scanning software;

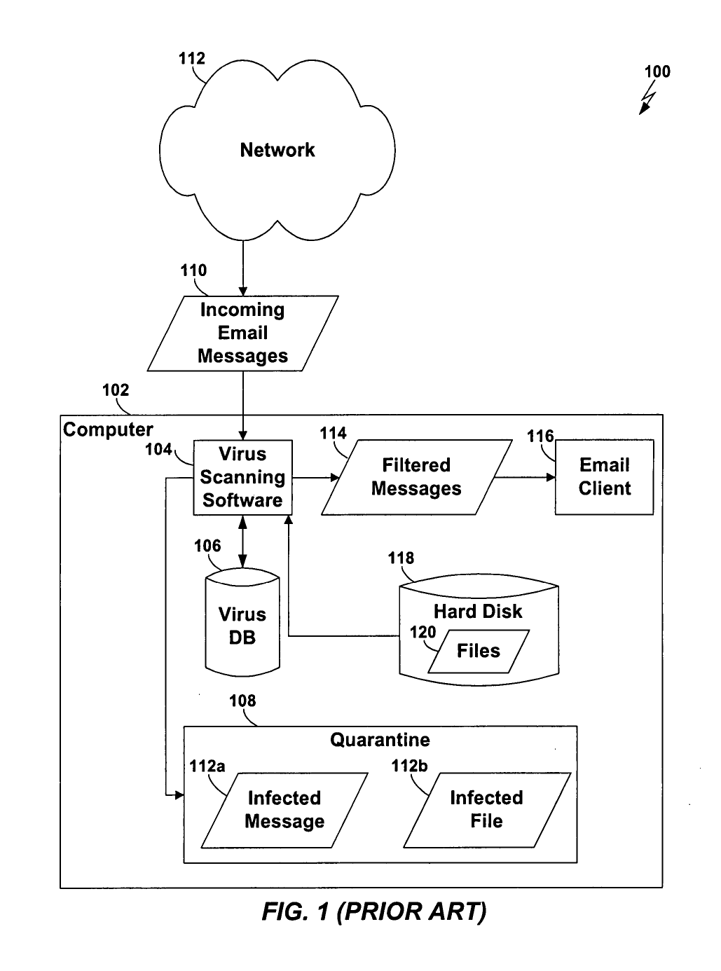

FIG. 2 is a flowchart of a method that is performed in one embodiment of the present invention to initialize virus protection in a computer system;

FIG. 3 is a block diagram of a system for implementing the method of FIG. 2 in one embodiment of the present invention;

FIG. 4 is a flowchart of a method that is performed in a first embodiment of the present invention to protect a computer system against virus infection;

FIG. 5 is a block diagram of a system for implementing the method of FIG. 4 in one embodiment of the present invention;

FIG. 6 is a flowchart of a method that is performed in a second embodiment of the present invention to protect a computer system against virus infection; and

FIG. 7 is a block diagram of a system for implementing the method of FIG. 6 in one embodiment of the present invention.

### DETAILED DESCRIPTION

In one aspect of the present invention, techniques are disclosed for automatically scanning and detecting the presence of any unauthorized files and/or processes in a computer system, such as a critical and/or embedded computer system. The techniques disclosed herein may, for example, be implemented in software, which may be installed on each computer system to be protected against viruses and/or other malicious programs.

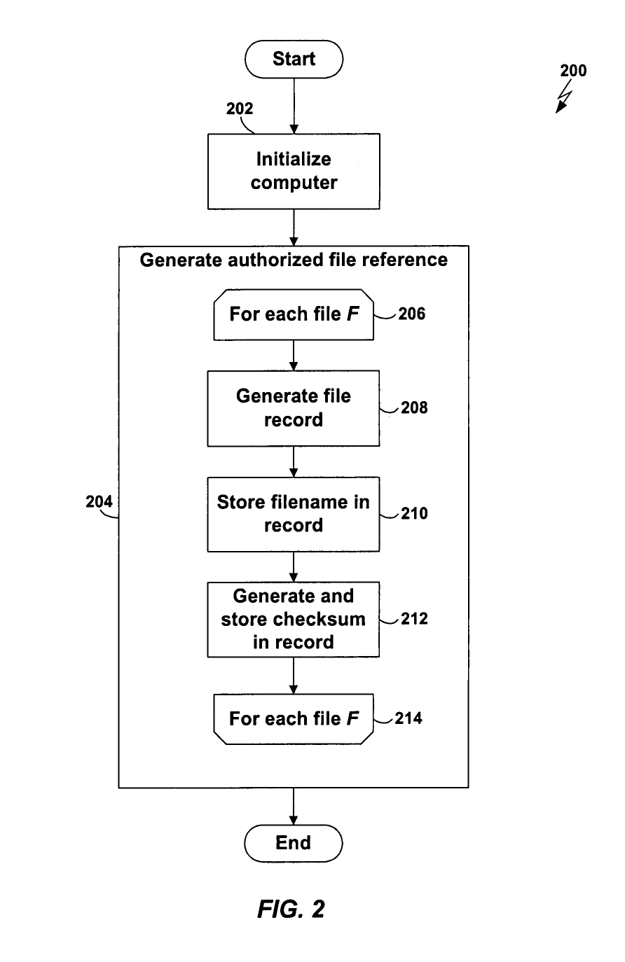

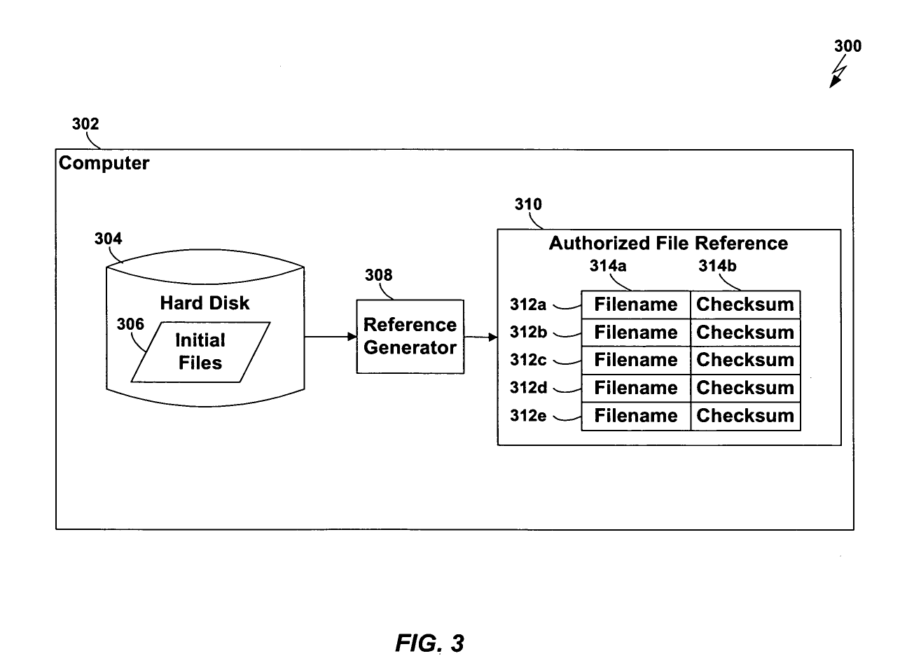

Referring to FIG. 2, a flowchart is shown of a method 200 that is performed in one embodiment of the present invention to initialize virus protection in a computer system. Referring to FIG. 3, a block diagram is shown of a system 300 for implementing the method 200 of FIG. 2 in one embodiment of the present invention. The system 300 includes a computer 302. The method 202 initializes the computer 302 (step 202). Step 202 may include, for example, installing an operating system on the computer 302, installing desired application programs on the computer 302, configuring device drivers on the computer 302, and performing any other configuration operations on the computer 302 that are necessary to initialize it for its intended use.

Production equipment (so-called “systems”), including but not limited to equipment used in pharmaceutical and biopharmaceutical production, often has components that exercise automated or manual system control. Traditionally such control systems have hardware and software parts, which together enable operators to switch vales, read sensor values, and in general interactively control the system during the production process. Such control activity can be automated in part or in toto. For example, the system may be programmed to execute a certain recipe of prescribed activities without the supervision of an operator. Contemporary designs use a variety of designs and software components, ranging from PLC (Programmable logic controllers)-driven stand-alone systems, over designs using various DCS (decentralized control systems), to systems using stand-alone or embedded PCs (personal computers).

Typical systems manufactured by Millipore Corporation currently use an Alan-Bradley PLC and a Dell PC running the Microsoft Windows XP operating system. Such systems employ PLC-code, Windows components, and Intellution iFIX software as the main software components to exercise machine control. A Millipore Integritest® instrument typically includes a PC running the Windows NT Embedded or Windows XP Embedded operating systems, and exercises device control through an interface board in the PC. Such systems typically include one or more application software programs, typically created by Millipore Corporation.

During the process of producing such systems, an initialization may be performed against the content of the original master disk that is used to produce the systems. At the customer site such pharmaceutical production systems typically undergo substantial testing during procedures called Installation Qualification (IQ), Operational Qualification (OQ) and System Acceptance Test (SAT). An initialization may, for example, be performed without connecting the computer 302 to a network to minimize the likelihood that the computer 302 will become infected with a virus during the initialization process, for example as part of the IQ, OQ or SAT process of the equipment that the computer 302 controls when executed at the customer site. Some systems may have a suitable authorized file reference already on the master hard disk used when the system is produced. In such a case it is not necessary to performing a separate step of generating the authorized file reference before performing the remainder of the method 200.

The process of initializing the computer 302 (step 202) will result in the storage of a plurality of initial files 306 on the hard disk 304. Such files 306 may include, for example, operating system files, application program files, and user profiles. Assuming that the hard disk 304 contained no files prior to the initialization performed in step 202, it may be assumed that the initial files 306 stored on the hard disk 304 were installed during initialization in step 202 and therefore contain only authorized files and no computer viruses or other malicious programs.

The computer 302 also includes a reference generator 308 which may, for example, be a computer program installed during the initialization process in step 202. The reference generator 308 generates an authorized file reference 310 containing information identifying the initial files 306 (step 204). As will be described in more detail below, the authorized file reference 310 may subsequently be used to determine whether unauthorized, and potentially malicious, software has subsequently been installed on the computer 302.

In the example illustrated in FIG. 3, the authorized file reference 310 is implemented as a list containing a plurality of records 312a-e, each of which contains information about a corresponding one of the initial files 306. Although only five records 312a-e are shown in FIG. 3 for ease of illustration, in an actual system the number of records in the reference 310 may reach the number of files 306. To generate the reference 310, the reference generator 308 enters a loop over each file F in the set of initial files 306 (step 206). The reference generator 308 generates a record in the file reference 310 corresponding to file F (step 208). Record 312a, for example, may be generated to contain information about the first file in the set of initial files 306.

The reference generator 308 stores the filename of file F in filename field 314a of the record generated in step 208 (step 210). The reference generator 308 generates a checksum for file F using any of a variety of well-known techniques, and stores the checksum in checksum field 314b of the record generated in step 208 (step 212). The reference generator 308 repeats steps 208-212 for the remaining files in the set of initial files 306, thereby generating the remainder of the authorized file reference 310 (step 214).

Note that filename and checksum are merely two examples of file properties that may be generated and stored for each of the files 306. Examples of other properties that may be stored for each file include file creation date, file size, and expected frequency of file modification. Any combination of properties may be selected for representation in the authorized file reference 310. In the following description, it will be assumed that the authorized file reference 310 includes at least the filename of each of the initial files 306, and that the authorized file reference 310 is indexed by filename. Note that the term “filename” as used herein may refer either to a bare filename (such as “doc.txt”) or to a partial or complete file pathname (such as “data\doc.txt”, “c: \data\doc.txt”, or a location defined by Universal Naming Convention (UNC), such as “\\computername\directory\doc.text”).

Similarly, the authorized file reference 310 may contain information about computer resources other than the file system. For example, versions of the Microsoft Windows operating system use a data structure referred to as the “registry” to maintain information about the operating system and other software programs installed in the system. Viruses and other malicious code may modify information contained in the registry and thereby bring about harmful effects. It is desirable, therefore, to protect the registry against unauthorized modifications. In one embodiment of the present invention, the authorized file reference 310 identifies the state of the registry at the time the authorized file reference 310 was generated.

To achieve this result, step 204 of the method 200 illustrated in FIG. 2 may be modified to generate a record in the authorized file reference 310 for each registry entry. Each such record may contain, for example, the registry key and registry value name (which may perform the same function as the filenames 314a in the authorized file reference illustrated in FIG. 3) and a checksum generated from the registry value data (which may perform the same function as the checksums 314b in the authorized file reference illustrated in FIG. 3). Those having ordinary skill in the art will appreciate that the techniques disclosed herein for detecting unauthorized changes to files in the file system may be applied, additionally or alternatively, to detect unauthorized changes to registry entries in the registry. Therefore, references in the following discussion to “files” are equally applicable to “registry entries” and to other data structures for which protection against malicious code is desired.

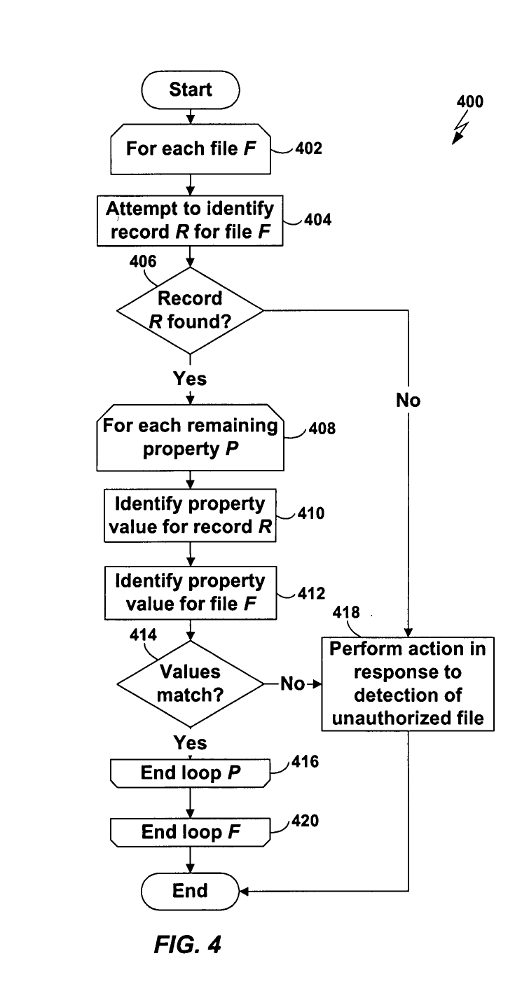

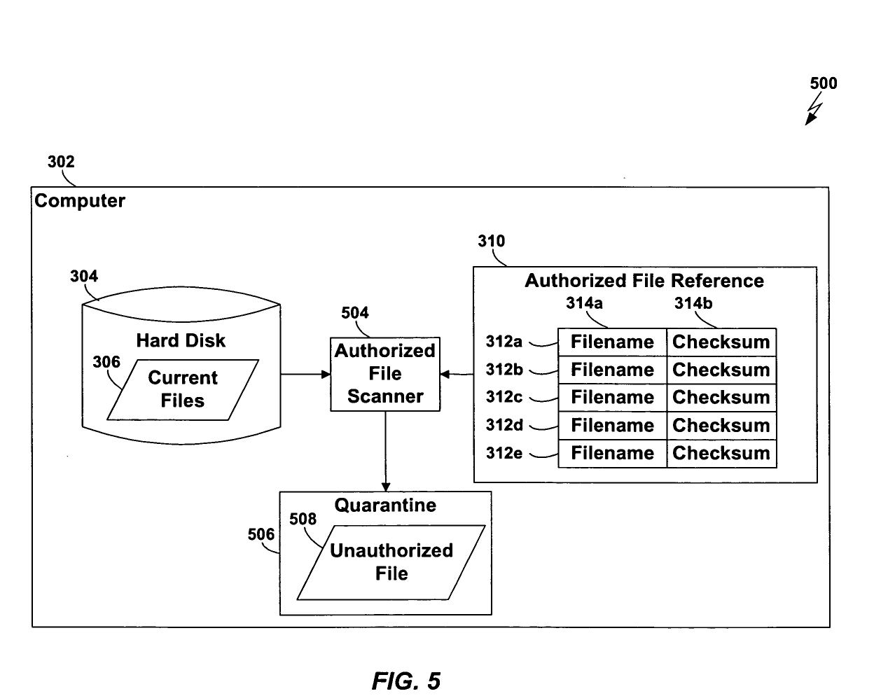

Referring to FIG. 4, a flowchart is shown of a method 400 that is performed in one embodiment of the present invention to protect a computer system (such as the system 300 shown in FIG. 3) against virus infection. Referring to FIG. 5, a block diagram is shown of a system 500 for implementing the method 400 of FIG. 4 in one embodiment of the present invention.

The hard disk 304 in the computer 302 illustrated in FIG. 5 contains a plurality of files 502. Note that the files 502 may contain the initial files 306 (FIG. 3) in addition to files that have been stored on the computer 302 after the initialization described above with respect to FIGS. 2-3.

The computer 302 includes an authorized file scanner 504, which may perform the method 400 illustrated in FIG. 4. The authorized file scanner 504 may, for example, be a computer program installed on the computer 302 during the initialization process described above with respect to FIGS. 2-3. The method 400 enters a loop over each file F in the computer 302 (step 402). The method 400 attempts to identify a record R in the authorized file reference 310 that corresponds to the file F (step 404). To perform step 404, the method 400 may, for example, identify the filename of file F and attempt to identify a record in the authorized file reference 310 having the same filename as file F.

If no record corresponding to file F exists in the authorized file reference 310, then file F is an unauthorized file that has been added to the computer 302 after the computer 302 was initialized. The method 400, therefore, performs an appropriate action in response to detection of the unauthorized file (step 418). Such actions may include, for example, notifying an administrator or other user of the computer 302 that the unauthorized file 508 has been detected (such as by turning on a light, sounding an alarm, or sending an email message or other message), automatically powering down the computer 302, disconnecting computer 302 from the network, storing the unauthorized file 508 in a quarantine 506 or by deleting the unauthorized file 508.

Note that not all files that are added to the hard disk 304 after the computer 302 is initialized are necessarily unauthorized. For example, authorized software programs may create data files or other files which are stored on the hard disk 304. Such files are examples of authorized files that are created and stored after initialization of the computer 302. Any of a variety of techniques may be used to prevent such files from being incorrectly identified by the authorized file scanner 504 as virus-infected files. For example, authorized software programs may store new files in predetermined locations. The authorized file reference 310 may be configured to automatically identify any files stored in such predetermined locations as authorized files. Alternatively or additionally, authorized software programs may assign names to new authorized files using a special file naming convention. Such a file naming convention may be used to generate file names which are not likely to be used by viruses, and which may therefore be used by the authorized file scanner 504 to distinguish between newly-generated authorized files and unauthorized files, such as viruses. Alternatively or additionally, authorized software programs may add records to the authorized file reference 310 corresponding to newly-generated authorized files, thereby preventing such files from being incorrectly identified by the authorized file scanner 504 as unauthorized files.

Returning to FIG. 4, if a record R corresponding to file F is found in the authorized file reference 310, the method 400 enters a loop over each remaining property P (i.e., each property other than filename) represented in the authorized file reference 310 (step 408). Assume, for example, that the only other property represented in the authorized file reference 310 is a file checksum.

The method 400 identifies the value of property P stored in record R (step 410). The method 400 identifies the value of property P for the file F (step 412). If, for example, property P is a file checksum, the method 400 may perform step 412 by generating a checksum for file F using the same checksum algorithm that was used to generate the checksum for record R. If file F and the file represented by record R are the same, then their checksums should be equal.

The method 400 determines whether the values of property P for file F and record R are equal (step 414). If the property values are not equal, then file F is not the same file as the file represented by record R. Such a situation may exist, for example, when the file represented by record R has been modified since its creation by a virus. In such a case, the method 400 takes an appropriate action in response to detection of the modified file F (step 418), as described above.

If the value of property P for file F and record R are equal, the method 400 continues to compare property values for any remaining properties (such as file creation date) (step 416). The method 400 then repeats steps 404-418 for the remaining ones of the files 502 on the hard disk 304. The method 400 thereby prevents any unauthorized ones of the files 502 from executing.

Modern computer operating systems are capable of executing multiple processes concurrently. Such operating systems typically use a data structure referred to as a “process table” to store information about the processes that are currently executing. Such information may include, for example, the filename and priority of each executing process.

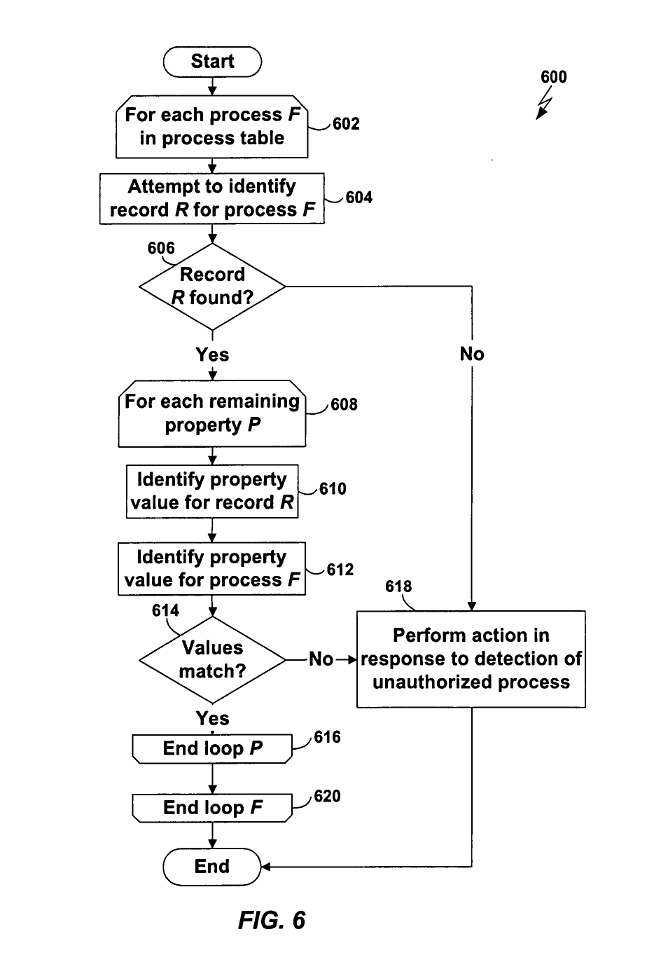

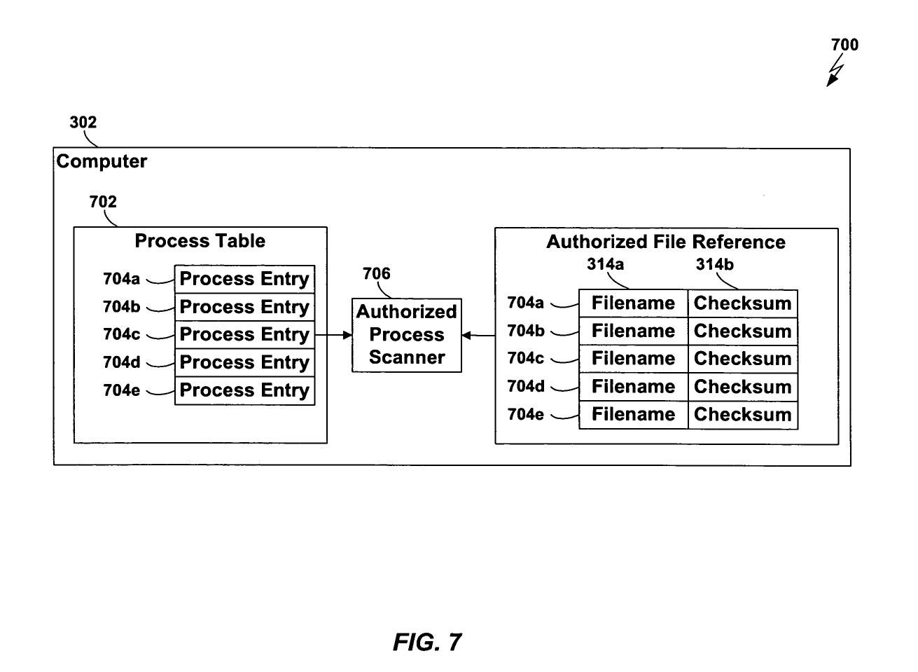

In another embodiment of the present invention, the process table is scanned using the authorized file reference 310 to determine whether any unauthorized processes are executing on the computer system. For example, referring to FIG. 6, a flowchart is shown of a method 600 that is performed in one embodiment of the present invention to protect a computer system against execution of viruses. Referring to FIG. 7, a block diagram is shown of a system 700 for implementing the method 600 of FIG. 6 in one embodiment of the present invention.

The computer 302 illustrated in FIG. 7 contains a process table 702 which, as mentioned above, may be a data structure maintained by the operating system (not shown) of the computer 302 to represent information about processes currently executing in the computer 302. In the example illustrated in FIG. 7, the process table 702 includes five entries 704a-e corresponding to the five processes executing in the computer 702. Assume for purposes of the present example that each of the entries 704a-e at least includes the filename of the executable file from which the corresponding process was launched.

The computer system 700 includes an authorized process scanner 706, which may perform the method 600 illustrated in FIG. 6. The authorized file scanner 706 may, for example, be a computer program installed on the computer 302 during the initialization process described above with respect to FIGS. 2-3. The method 600 enters a loop over each process F in the computer 302 (step 602). The method 600 attempts to identify a record R in the authorized file reference 310 that corresponds to the process F (step 604). To perform step 404, the method 600 may, for example, identify the filename of the file from which process F was launched, and attempt to identify a record in the authorized file reference 310 having the same filename as the file from which process F was launched.

If no record corresponding to process F exists in the authorized file reference 310, then process F is an unauthorized process, i.e., a process that was launched from an unauthorized file. The method 600, therefore, takes an appropriate action in response to detection of the unauthorized process F (step 618). Such actions may include, for example, notifying an administrator or other user of the computer 302 that an unauthorized process has been detected (such as by turning on a light, sounding an alarm, or sending an email message or other message), automatically powering down the computer 302, disconnecting computer 302 from the network, or terminating the process F.

If a record R corresponding to process F is found in the authorized file reference 310, the method 600 enters a loop over each remaining property P (i.e., each property other than filename) represented in the authorized file reference 310 (step 608). The method 600 identifies the value of property P stored in record R (step 610). The method 600 identifies the value of property P for the process F (step 612).

The method 600 determines whether the values of property P for process F and record R are equal (step 614). If the property values are not equal, then process F was not launched from the same file as the file represented by record R. Such a situation may exist, for example, when the file represented by record R has been modified since its creation by a virus. In such a case, the method 600 takes an appropriate action in response to detection of the modified process F (step 618), as described above.

If the value of property P for process F and record R are equal, the method 600 continues to compare property values for any remaining properties (such as file creation date) (step 616). The method 600 then repeats steps 604-618 for the remaining ones of the process table entries 704a-e. The method 600 thereby prevents any unauthorized processes from executing.

Note that the file-based techniques disclosed in conjunction with FIGS. 4-5 may be combined with the process-based techniques disclosed in conjunction with FIGS. 6-7. For example, the authorized file scanner 504 may periodically scan the files 502 on the hard disk 304 for unauthorized files, while the authorized process scanner 706 may periodically scan the process table 702 for unauthorized process entries, thereby providing two layers of protection against viruses and other malicious software. For example, the authorized file scanner 504 and/or the authorized process scanner 706 may scan the computer 302 whenever the computer 302 is idle. As a result, virus protection may be performed in an ongoing manner, thereby further decreasing the amount of time during which any virus infection will go undetected.

One advantage of various embodiments of the present invention is that they are particularly suited for use in conjunction with embedded computer systems, such as in use on pharmaceutical or biopharmaceutical production equipment. Such computer systems typically execute operating systems, such as the Microsoft® Windows® XP Embedded operating system, which include a relatively small number of files in comparison to full-fledged PC operating systems such as the Microsoft® Windows® XP operating system. Furthermore, embedded computer systems typically are configured to execute a relatively small and fixed number of application programs, and to interact with a relatively small and fixed number of peripheral devices. As a result, embedded computer systems typically include only a small number of files which are not expected to change significantly or frequently after the computer system has been initialized. As a result, the presence of an additional file on such a computer system is likely an indication of a virus infection or security breach, unlike in the case of a general-purpose PC, in which additional benign files are added frequently by software programs.

As a result, the techniques disclosed herein, which identify viruses based on the presence of unauthorized files, are particularly-well suited to use in conjunction with embedded computer systems and other special-purpose computer systems which are configured once for use, because the presence of new files in such systems is likely to indicate a virus infection or security breach. Although such techniques could be used in conjunction with a general purpose computer, such techniques would result in false positives due to the identification of benign files (such as newly-installed software, temporary files created by authorized applications, etc.) intentionally added by users as viruses. The techniques disclosed herein provide an advantage over conventional virus-scanning techniques, however, since such conventional techniques can only identify viruses which are predefined in the virus database. The techniques disclosed herein, by contrast, can identify entirely new viruses which are not defined in any virus database, because such viruses need not be defined by the reference 310. Instead the system's list of authorized files and processes defines a ‘self’ which in turn allows everything to be recognized as ‘foreign’ by definition. As a result, the techniques disclosed herein may be used to identify entirely new viruses before they have had an opportunity to cause damage, and without the need to add such a virus to a virus database or otherwise determine that a particular file is a virus based on its content or behavior. The “window of concern” will be significantly smaller in time on production systems protected by the techniques disclosed herein.

Furthermore, the techniques disclosed herein may be implemented on embedded computers, and other computers having a relatively small number of files, without consuming significant computing resources, unlike conventional virus-scanning techniques, which tend to consume significant computing resources. If the reference 310 contains a relatively small number of entries (as would be true in the case of an embedded computer system), the reference 310 may be compared to files/processes relatively quickly.

Because the techniques disclosed herein do not rely on a virus definition database, the techniques disclosed herein may be used to provide a foolproof guarantee that a particular computer is virus-free, both initially and at any subsequent point in the future, so long as the reference 310 is created based on a virus-free computer. Because the reference 310 is created at the time of manufacture and/or initial system configuration, the reference 310 can be guaranteed with a very high degree of confidence to represent a state of the computer that is virus free. The techniques disclosed herein, therefore, may be used to provide a much higher degree of confidence that a particular computer is virus-free than conventional virus-scanning techniques, which are capable of providing a degree of confidence that is only as high as the quality of the current virus database.

The high degree of protection provided by the techniques disclosed herein is particularly important in the context of critical computer systems, such as those used in pharmaceutical production environments. Such protection will become increasingly important as conventional operating systems (such as Windows XP Embedded) and conventional network protocols (such as TCP/IP) are increasingly adopted in production environments, and as the computers in such environments are increasingly being connected to other, possibly public, networks, thereby exposing themselves to increased risk of virus infection.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The techniques disclosed herein may be performed at any of a variety of times and in response to any of a variety of triggers. For example, the virus-scanning techniques disclosed with respect to FIGS. 4-7 may be performed in response to a specific command by a user to perform such scanning. Alternatively, scanning may be performed automatically on a periodic basis (e.g., every minute, hour, or day), and/or whenever the computer 302 is idle.

Any of a variety of actions may be taken in response to detection of an unauthorized file or process. For example, as described above, an authorized file may be deleted or placed into quarantine, and an unauthorized process may be terminated. Additionally or alternatively, detection of an unauthorized file/process may trigger an alarm, initialize notifications (e.g., an email message or telephone call to a system administrator), or automatically initiate self-protecting behavior, such as a system power-down.

As described above, the techniques disclosed herein may be used in conjunction with critical computer systems. One example of a computer system is a computer system that is used in the manufacture of a pharmaceutical composition intended for the therapy of human diseases, and that performs at least one procedure that is both automated and critical to the safety or efficacy of said pharmaceutical composition. Safety and efficacy may be defined by reference to 21 C.F.R. Parts 300 et seq. The “criticality” of the procedure depends on the consequences that can ensue from unintended procedural deviations, not on whether functionally-equivalent alternatives are available. For example, it is possible for certain applications to replace a membrane-based virus removal procedure with photolytic viral inactivation. This does not mean, however, that the membrane-based approach is not “critical.” Rather, regardless of its replaceability, a procedure should be considered “critical” if a bad or otherwise “unqualifiable” (i.e., unsafe or uneffective) batch of drugs can result if the procedure is poorly executed (i.e., not conducted as intended), particularly if directly caused by unauthorized electronic interference or data corruption.

Representative examples of unauthorized electronic interference or data corruption include the execution of code that maliciously interferes or changes a CPU internal clock to the detriment of time-dependent or time-regulated processes (e.g., by allowing a filtration device to be used beyond its qualified life expectancy); the execution of code that changes or erases data used to drive equipment and thereby comprises the functionality thereof (e.g., by reinitializing or reassigning operation of pumps and valves used to mediate the flow of fluid to and from a filtration device); or the spawning and/or replication of spurious data, inserted without authorization, into recorded data collected during a pharmaceutical manufacturing process that brings into doubt whether the process was conducted “as qualified.”

Computer-automated filtration systems typically monitor and regulate flow rate and pressure. Computer-automation can also be used to record, process, and compute data related to these and other filtration variables. Other filtration variables include, but are not limited to, temperature, pH, concentration, viscosity, atmospheric pressure, electrochemical properties (e.g., capacitance and resistivity), and optical properties (e.g., absorption, reflection, transmission, and diffraction).

Examples of filtration devices, include but are not limited to, chromatography devices, tangential flow filtration devices, normal flow filtration devices, deep bed filter devices, hollow fiber filtration devices, and density gradient filter devices. The filtration device can be used, for example, for prefiltration, primary or secondary clarification, fluid polishing, microfiltration, ultrafiltration, virus removal, extraction, fractionation, isolation, diafiltration, and the like. Commercially-available filtration devices suited for the industrial manufacture of human pharmaceuticals can be obtained from several sources, such as Millipore Corporation of Billerica, Mass. (e.g., “Millistak”-, “Prostak”-, Opticap”-, “Pellicon”-, “Polygard”-, and “Viresolve”-branded filter devices); Pall Corporation of East Hills, N.Y. (e.g., “Mustang”-, “Filtron”-, “PallSep”-, “Microza”-. “Ultipor”-, and “Ultipleat”-branded filter devices); and Cuno Corporation of Meriden, Conn. (e.g., “MicroFluor”-, “Betafine”-, “PolyNet”-, “PolyPro”-, and “Zeta Plus”-branded filter devices). Filtration devices or particular interest are also disclosed, for example, in U.S. Pat. No. 6,712,963, issued to K. G. Schick on Mar. 30, 2004; U.S. Pat. No. 6,464,084, issued to J. L. Pulek on Oct. 15, 2002; and U.S. Pat. No. 6,712,966, Issued to J. L. Pulek et al. on Mar. 30, 2004.

In general, for pharmaceutical manufacturing processes that involve several sequential, progressively more selective filtration steps (e.g., pre-clarification, followed by primary and secondary clarification, followed by polishing, followed by virus removal), the filtration steps that occur furthest downstream in the process are often the most critical to the safety and/or efficacy of the resultant pharmaceutical product. Such final (or otherwise terminal) filtration steps often involve the use of so-called “ultrafiltration” membranes, i.e., membranes that have nominal pore sizes in the low micron and sub-micron range, which are often specifically engineered for the removal from a final pharmaceutical product of bacteria, viruses, pyrogens, and the like. The computer-implemented security process, in an embodiment of the present invention, is used to secure specifically the automated-computer processes critical to the conduct of such ultrafiltration steps.

Another example of computer-automated devices used in pharmaceutical manufacturing processes are filter integrity testers. Such devices exercise computer-controlled pressure profiles and flow measurements on filter cartridges to examine the integrity of the filtration device and the membrane(s) it contains. Commercially available devices suitable for industrial manufacture of human pharmaceuticals are available from several sources, such as the Integritest® Exacta series of instruments available from Millipore Corporation, the FlowStar® integrity test system available from Pall Corporation, and the Sartocheck® integrity tester available from Sartorius Corporation.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a web-based markup-language (such as HTML or XML), any kind of server-side scripting, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

1. In the manufacture of a pharmaceutical composition intended for the therapy of human diseases, wherein said manufacture involves at least one procedure that is both automated by a computer and critical to the safety or efficacy of said pharmaceutical composition, the invention comprising the steps of:
(A) creating on said computer an authorized reference that identifies a plurality of reference files authorized for use by said computer; and
(B) operating on said computer a computer-implemented method comprising steps of:
(1) identifying the authorized reference created on said computer;
(2) determining, by reference to the authorized reference, whether a particular file stored in the computer is authorized for use by the computer; and
(3) if it is determined that the particular file is not authorized for use by the computer, performing a first predetermined action.

2. The manufacture of a pharmaceutical composition according to claim 1, wherein said at least one procedure is a computer-automated filtration procedure, said computer automatically monitors and regulates the flow rate and pressure of a fluid conducted through a filtration device, and said fluid is a precursor of said pharmaceutical composition.

3. The manufacture of a pharmaceutical composition according to claim 1, wherein said filtration is a tangential flow filtration device incorporation ultrafiltration membranes.

4. The manufacture of a pharmaceutical composition according to claim 1, wherein the first predetermined action comprises preventing the particular file from being used by the computer system.

5. The manufacture of a pharmaceutical composition according to claim 1, wherein the first predetermined action comprises notifying a user of the computer system that the particular file is not authorized for use by the computer system.

6. The manufacture of a pharmaceutical composition according to claim 1, wherein the first predetermined action comprises powering down the computer system.

7. The manufacture of a pharmaceutical composition according to claim 6, wherein the first predetermined action comprises disconnecting the computer from a network.

8. The manufacture of a pharmaceutical composition according to claim 1, wherein the authorized file reference identifies the plurality of reference files by filename.

9. The manufacture of a pharmaceutical composition according to claim 1, wherein the authorized file reference identifies the plurality of reference files by checksum.

10. The manufacture of a pharmaceutical composition according to claim 1, wherein the step (B)(2) comprises steps of:
(B)(2)(a) identifying a record in the authorized file reference corresponding to the particular file;
(B)(2)(b) comparing a value of a selected property of the record to a value of the selected property of the particular file;
(B)(2)(c) determining that the particular file is authorized for use by the computer system if the values compared in step (B)(2) are equal to each other; and
(B)(2)(d) otherwise, determining that the particular file is not authorized for use by the computer system.

11. The manufacture of a pharmaceutical composition according to claim 10, wherein the selected property comprises filename.

12. The manufacture of a pharmaceutical composition according to claim 10, wherein the selected property comprises file checksum.

13. The manufacture of a pharmaceutical composition according to claim 10, wherein the step (B)(2) further comprises a step of:
(B)(2)(e) repeating steps (B)(2)(b)-(B)(2)(d) for each of a plurality of properties.

14. The manufacture of a pharmaceutical composition according to claim 1, wherein the step (B)(2) comprises steps of:
(B)(2)(a) determining that the particular file is authorized for use by the computer system if the authorized file reference contains a record corresponding to the particular file; and
(B)(2)(b) otherwise, determining that the particular file is not authorized for use by the computer system.

15. The manufacture of a pharmaceutical composition according to claim 1, wherein the particular file comprises one of a plurality of particular files stored in the computer system, and wherein the step (B) further comprises a step of:
(B)(4) repeating steps (B)(2) and (B)(3) for each of the plurality of particular files.

16. The manufacture of a pharmaceutical composition according to claim 1, wherein the computer system comprises an embedded computer system.

17. The manufacture of a pharmaceutical composition according to claim 1, wherein the step (B) further comprises a step of:
(B)(4) determining, by reference to the authorized file reference, whether a particular process executing in the computer system is authorized for execution in the computer system; and
(B)(5) if it is determined that the particular process is not authorized for execution in the computer system, performing a second predetermined action.

18. The manufacture of a pharmaceutical composition according to claim 17, wherein the second predetermined action comprises terminating the particular process.

19. The manufacture of a pharmaceutical composition according to claim 17, wherein the second predetermined action comprises notifying a user of the computer system that the particular process is not authorized for use by the computer system.

20. The manufacture of a pharmaceutical composition according to claim 17, wherein the second predetermined action comprises powering down the computer system.

21. The manufacture of a pharmaceutical composition according to claim 17, wherein the second predetermined action comprises disconnecting the computer system from a network.

22. The manufacture of a pharmaceutical composition according to claim 1, wherein the plurality of reference files comprises a plurality of files in a file system.

23. The manufacture of a pharmaceutical composition according to claim 1, wherein the plurality of reference files comprises a plurality of registry entries in an operating system registry.

24. An apparatus for use in the manufacture of a pharmaceutical composition intended for the therapy of human diseases, wherein said manufacture involves at least one procedure that is both automated by a computer and critical to the safety or efficacy of said pharmaceutical composition, the invention comprising:
means for creating on said computer an authorized reference that identifies a plurality of reference files authorized for use by said computer; and
means for identifying the authorized reference created on said computer;
first determination means for determining, by reference to the authorized reference, whether a particular file stored in the computer is authorized for use by the computer; and
means for performing a first predetermined action if it is determined that the particular file is not authorized for use by the computer.

25. The apparatus of claim 24, wherein said at least one procedure is a computer-automated filtration procedure, said computer automatically monitors and regulates the flow rate and pressure of a fluid conducted through a filtration device, and said fluid is a precursor of said pharmaceutical composition.

26. The apparatus of claim 24, wherein said filtration is a tangential flow filtration device incorporation ultrafiltration membranes.

27. The apparatus of claim 24, wherein the first predetermined action comprises preventing the particular file from being used by the computer system.

28. The apparatus of claim 24, wherein the first predetermined action comprises notifying a user of the computer system that the particular file is not authorized for use by the computer system.

29. The apparatus of claim 24, wherein the first predetermined action comprises powering down the computer system.

30. The apparatus of claim 24, wherein the first predetermined action comprises disconnecting the computer from a network.

31. The apparatus of claim 24, wherein the authorized file reference identifies the plurality of reference files by filename.

32. The apparatus of claim 24, wherein the authorized file reference identifies the plurality of reference files by checksum.

33. The apparatus of claim 24, wherein the first determination means comprises:
means for identifying a record in the authorized file reference corresponding to the particular file;
means for comparing a value of a selected property of the record to a value of the selected property of the particular file;
second determination means for determining that the particular file is authorized for use by the computer system if the values compared are equal to each other; and
third determination means for determining that the particular file is not authorized for use by the computer system if the values compared are not equal to each other.

34. The apparatus of claim 33, wherein the selected property comprises filename.

35. The apparatus of claim 33, wherein the selected property comprises file checksum.

36. The apparatus of claim 33, wherein the means for determining further comprises:
means for repeatedly activating the means for comparing, the second determination means, and the third determination means for each of a plurality of properties.

37. The apparatus of claim 24, wherein the first determination means comprises:
second determination means for determining that the particular file is authorized for use by the computer system if the authorized file reference contains a record corresponding to the particular file; and
third determination means for determining that the particular file is not authorized for use by the computer system if the authorized file reference does not contain a record corresponding to the particular file.

38. The apparatus of claim 24, wherein the particular file comprises one of a plurality of particular files stored in the computer system, and wherein the apparatus further comprises:
means for repeatedly activating the first determination means and the means for performing the first predetermined action for each of the plurality of particular files.

39. The apparatus of claim 24, wherein the computer system comprises an embedded computer system.

40. The apparatus of claim 24, further comprising:
second determination means for determining, by reference to the authorized file reference, whether a particular process executing in the computer system is authorized for execution in the computer system; and
means for performing a second predetermined action if it is determined that the particular process is not authorized for execution in the computer system.

41. The apparatus of claim 40, wherein the second predetermined action comprises terminating the particular process.

42. The apparatus of claim 40, wherein the second predetermined action comprises notifying a user of the computer system that the particular process is not authorized for use by the computer system.

43. The apparatus of claim 40, wherein the second predetermined action comprises powering down the computer system.

44. The apparatus of claim 40, wherein the second predetermined action comprises disconnecting the computer system from a network.

45. The apparatus of claim 24, wherein the plurality of reference files comprises a plurality of files in a file system.

46. The apparatus of claim 24, wherein the plurality of reference files comprises a plurality of registry entries in an operating system registry.

47. A computer-implemented method comprising steps of:
(A) identifying an authorized file reference which identifies a plurality of reference files authorized for use by a computer system;
(B) determining, by reference to the authorized file reference, whether a particular file stored in the computer system is authorized for use by the computer system; and
(C) if it is determined that the particular file is not authorized for use by the computer system, performing a first predetermined action.

48. The method of claim 47, wherein the first predetermined action comprises preventing the particular file from being used by the computer system.

49. The method of claim 47, wherein the first predetermined action comprises notifying a user of the computer system that the particular file is not authorized for use by the computer system.

50. The method of claim 47, wherein the first predetermined action comprises powering down the computer system.

51. The method of claim 47, wherein the plurality of reference files comprises a plurality of files stored in the computer system at a reference point in time, and wherein the method further comprises a step of:
(D) prior to the step (A), generating the authorized file reference by storing in the authorized file reference information descriptive of the plurality of reference files stored in the computer system at the reference point in time.

52. The method of claim 51, wherein the plurality of reference files comprises all of the files stored in the computer system at the reference point in time.

53. The method of claim 47, wherein the authorized file reference identifies the plurality of reference files by filename.

54. The method of claim 47, wherein the authorized file reference identifies the plurality of reference files by checksum.

55. The method of claim 47, wherein the step (B) comprises steps of:
(B)(1) identifying a record in the authorized file reference corresponding to the particular file;
(B)(2) comparing a value of a selected property of the record to a value of the selected property of the particular file;
(B)(3) determining that the particular file is authorized for use by the computer system if the values compared in step (B)(2) are equal to each other; and
(B)(4) otherwise, determining that the particular file is not authorized for use by the computer system.

56. The method of claim 55, wherein the selected property comprises filename.

57. The method of claim 55, wherein the selected property comprises file checksum.

58. The method of claim 55, wherein the step (B) further comprises a step of:
(B)(5) repeating steps (B)(2)-(B)(4) for each of a plurality of properties.

59. The method of claim 47, wherein the step (B) comprises steps of:
(B)(1) determining that the particular file is authorized for use by the computer system if the authorized file reference contains a record corresponding to the particular file; and
(B)(2) otherwise, determining that the particular file is not authorized for use by the computer system.

60. The method of claim 47, wherein the particular file comprises one of a plurality of particular files stored in the computer system, and wherein the method further comprises a step of:
(D) repeating steps (B) and (C) for each of the plurality of particular files.

61. The method of claim 47, wherein the computer system comprises an embedded computer system.

62. The method of claim 47, further comprising steps of:
(D) determining, by reference to the authorized file reference, whether a particular process executing in the computer system is authorized for execution in the computer system; and
(E) if it is determined that the particular process is not authorized for execution in the computer system, performing a second predetermined action.

63. The method of claim 62, wherein the second predetermined action comprises terminating the particular process.

64. The method of claim 62, wherein the second predetermined action comprises notifying a user of the computer system that the particular process is not authorized for use by the computer system.

65. The method of claim 62, wherein the second predetermined action comprises powering down the computer system.

66. The method of claim 62, wherein the second predetermined action comprises disconnecting the computer system from a network.

67. The method of claim 47, wherein the plurality of reference files comprises a plurality of files in a file system.

68. The method of claim 47, wherein the plurality of reference files comprises a plurality of registry entries in an operating system registry.

69. An apparatus comprising:
means for identifying an authorized file reference which identifies a plurality of reference files authorized for use by a computer system;
first determination means for determining, by reference to the authorized file reference, whether a particular file stored in the computer system is authorized for use by the computer system; and
means for performing a first predetermined action if it is determined that the particular file is not authorized for use by the computer system.

70. The apparatus of claim 69, wherein the first predetermined action comprises preventing the particular file from being used by the computer system.

71. The apparatus of claim 69, wherein the first predetermined action comprises notifying a user of the computer system that the particular file is not authorized for use by the computer system.

72. The apparatus of claim 69, wherein the first predetermined action comprises powering down the computer system.

73. The apparatus of claim 69, wherein the first predetermined action comprises disconnecting the computer from a network.

74. The apparatus of claim 69, wherein the plurality of reference files comprises a plurality of files stored in the computer system at a reference point in time, and wherein the apparatus further comprises:
means for generating the authorized file reference by storing in the authorized file reference information descriptive of the plurality of reference files stored in the computer system at the reference point in time.

75. The apparatus of claim 74, wherein the plurality of reference files comprises all of the files stored in the computer system at the reference point in time.

76. The apparatus of claim 69, wherein the authorized file reference identifies the plurality of reference files by filename.

77. The apparatus of claim 69, wherein the authorized file reference identifies the plurality of reference files by checksum.

78. The apparatus of claim 69, wherein the first determination means comprises:
means for identifying a record in the authorized file reference corresponding to the particular file;
means for comparing a value of a selected property of the record to a value of the selected property of the particular file;
second determination means for determining that the particular file is authorized for use by the computer system if the values compared are equal to each other; and
third determination means for determining that the particular file is not authorized for use by the computer system if the values compared are not equal to each other.

79. The apparatus of claim 78, wherein the selected property comprises filename.

80. The apparatus of claim 78, wherein the selected property comprises file checksum.

81. The apparatus of claim 78, wherein the first determination means further comprises:
means for repeatedly activating the means for comparing, the second determination means, and the third determination means for each of a plurality of properties.

82. The apparatus of claim 69, wherein the first determination means comprises:
second determination means for determining that the particular file is authorized for use by the computer system if the authorized file reference contains a record corresponding to the particular file; and
third determination means for determining that the particular file is not authorized for use by the computer system if the authorized file reference does not contains a record corresponding to the particular file.

83. The apparatus of claim 69, wherein the particular file comprises one of a plurality of particular files stored in the computer system, and wherein the apparatus further comprises:
means for repeatedly activating the first determination means and the means for performing the first predetermined action for each of the plurality of particular files.

84. The apparatus of claim 69, wherein the computer system comprises an embedded computer system.

85. The apparatus of claim 69, further comprising:
second means for determining, by reference to the authorized file reference, whether a particular process executing in the computer system is authorized for execution in the computer system; and
means for performing a second predetermined action if it is determined that the particular process is not authorized for execution in the computer system.

86. The apparatus of claim 85, wherein the second predetermined action comprises terminating the particular process.

87. The apparatus of claim 85, wherein the second predetermined action comprises notifying a user of the computer system that the particular process is not authorized for use by the computer system.

88. The apparatus of claim 85, wherein the second predetermined action comprises powering down the computer system.

89. The apparatus of claim 85, wherein the second predetermined action comprises disconnecting the computer system from a network.

90. The apparatus of claim 69, wherein the plurality of reference files comprises a plurality of files in a file system.

91. The apparatus of claim 69, wherein the plurality of reference files comprises a plurality of registry entries in an operating system registry.
